(19) United States
(12) Patent Application Publication
(10) Pub. No.: US 2026/0094417 A1
(43) Pub. Date: Apr. 2, 2026

(54) IMAGED-BASED OPERATION WITH MACHINE LEARNING

(71) Applicant: Ford Global Technologies, LLC, Dearborn, MI (US)

(72) Inventors: Robert Relyea, San Mateo, CA (US); Anuja Anil Shirsat, Gilbert, AZ (US); Akhil Perincherry, Corvallis, OR (US); Kyoung Min Lee, Ypsilanti, MI (US)

(73) Assignee: Ford Global Technologies, LLC, Dearborn, MI (US)

(21) Appl. No.: 18/898,873

(22) Filed: Sep. 27, 2024

(51) Int. Cl. G06V 10/774; G06V 10/32; G06V 10/82; G06V 20/56

(52) U.S. Cl. CPC G06V 10/774; G06V 10/32; G06V 10/82; G06V 20/56

(57) ABSTRACT

Fisheye images that include objects at first, second, and third angles into rectilinear images are transformed with a first image transformation and the rectilinear images are transformed into bird's eye view images with a second image transformation. The bird's eye view images can be transformed into multiple images that include objects at multiple angles intermediate between the first, second, and third angles to generate a training dataset that includes ground truth regarding the multiple angles with a third image transformation. A machine learning model can be trained with the training dataset. A machine such as a vehicle can be operated with output from the machine learning model.

### BACKGROUND

Computers can operate systems and devices including vehicles, robots, drones, and/or object tracking systems. Data including images can be acquired by sensors and processed by a computer to determine a trajectory for a system with respect to an environment and with respect to objects in the environment. A computer may use the trajectory to operate the system or operate components thereof in the environment.

### BRIEF DESCRIPTION OF THE DRAWINGS

FIG. 1 is a block diagram of an example image-based system.

FIG. 2 is a diagram of an example fisheye image.

FIG. 3 is a diagram of an example rectilinear image.

FIG. 4 is a diagram of an example bird's eye view image.

FIG. 5 is a diagram of an example rotated image.

FIG. 6 is a diagram of an example synthetic image.

FIG. 7 is a diagram of an example system for transforming images.

FIG. 8 is a diagram of an example system for training a machine learning model.

FIG. 9 is a flowchart diagram to operate a vehicle based on a training a machine learning model.

### DETAILED DESCRIPTION

Systems that move and/or that have mobile components, including vehicles, robots, drones, cell phones etc., can be operated by acquiring sensor data, including data regarding an environment around the system, and processing the sensor data to determine locations of objects in the environment around the system. The determined location data could be processed to determine operation of the system or portions of the system. For example, a robot could determine the location of another nearby robot's arm. The determined robot arm location could be used by the robot to determine a path upon which to move a gripper to grasp a workpiece without encountering the other robot's arm. In another example, a vehicle could determine its location with respect to an environment around the vehicle and locations of objects such as the roadway and other vehicles in the environment. The vehicle could use its determined location and the determined locations of the objects to determine a path upon which to operate while maintaining a predetermined relationship to the objects. Vehicle operation will be used herein as a non-limiting example of object identity and location determination in the description below.

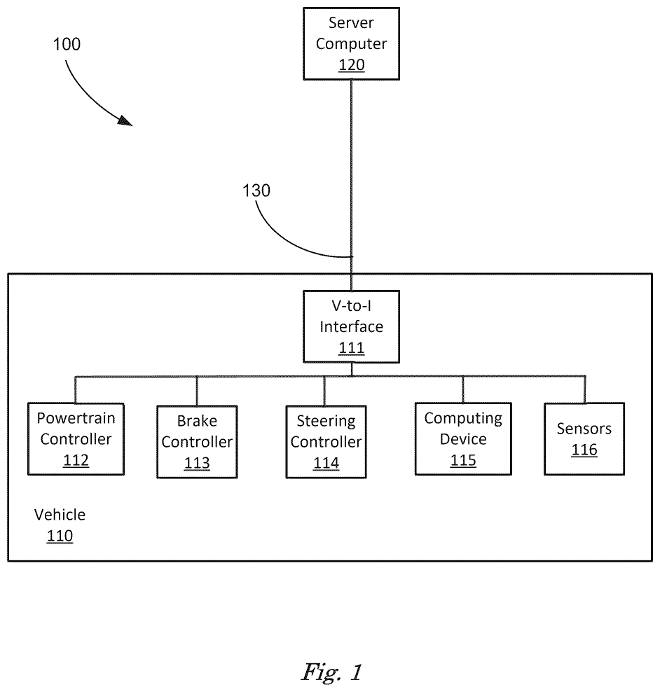

A machine learning model can be trained and installed in a computing device in a vehicle to receive sensor data from sensors included in the vehicle. The machine learning model can determine predictions regarding the received sensor data to assist in operating the vehicle. For example, a machine learning model can be trained to receive images from a video camera and determine a predicted state for objects in an environment around the vehicle. A predicted state output from the machine learning model can include predicting a location and orientation of an object with respect to the vehicle including a distance and an angle between the vehicle and the object. The object prediction data can be used by a computing device included in the vehicle to determine a trajectory that the vehicle could travel on to reach a predicted future location. The computing device can then direct the vehicle to travel on the trajectory by issuing commands to controllers which operate vehicle components such as propulsion, steering, and brakes as described below in relation to FIG. 1.

In an example of operating a vehicle based on a trained machine learning model, a rear-facing video camera included in a vehicle can acquire images of a vehicle trailer parked behind the vehicle. By determining a location and orientation of the hitch coupler portion of the vehicle trailer with respect to a hitch ball attached to the vehicle, a machine learning model can determine a vehicle trajectory that can be translated by the computing device into commands to be sent to controllers included in the vehicle to command vehicle components. The vehicle components can be commanded to operate the vehicle to bring the hitch ball to a location under the hitch coupler to permit the hitch coupler to be lowered onto the hitch ball and connect the vehicle trailer to the vehicle for towing.

Obtaining useful results from a trained machine learning system can depend upon the ability of a machine learning system to generalize a training dataset to achieve useful results based on real world input data. Useful results in the context of this application are results that operate the vehicle to reach a goal, such as placing a hitch ball under a hitch coupler while maintaining bounds on vehicle speed, rates of change of speed and direction, and braking force. Generating a training dataset that includes a range of trailer types, trailer locations and orientations, and environmental conditions including lighting and weather can require thousands or millions of images. Each image must be processed to determine ground truth regarding the location and orientation of the hitch coupler with respect to the hitch ball to permit training the machine learning model. Ground truth is data that is acquired independently from the machine learning model training process. For example, the location and orientation of the hitch coupler can be physically measured at the time the image data is acquired. In other examples, image processing software, such as Adobe Photoshop, can be used to determine the location and orientation of a hitch coupler in real world coordinates. Adobe Photoshop is available from Adobe, Inc., at Adobe.com as of the filing date of this application. Acquiring and generating ground truth for a comprehensive dataset of real world images for training a machine learning model can require more time and computing resources than are available.

Another technique for generating a training dataset is generating simulated images. An example of a software program for generating a training dataset of photorealistically rendered images for training a machine learning model is Unreal Engine, available from Epic Games, Inc., at unrealengine.com as of the filing data of this application. Photorealistically rendered images have the advantage that the input data used to generate the image data includes the ground truth regarding the location and orientation of objects in the environment around the vehicle. A possible shortcoming of training a machine learning model using simulated images is domain shift. Domain shift occurs when there is disparity between data in a training domain and data in a target domain where the machine learning model will be used, e.g., simulated images versus real world images. Domain shift can cause a machine learning model to mis-identify or mis-locate objects, for example.

Techniques described herein for generating training datasets can enhance machine learning model training by generating images for training datasets based on a limited number of acquired real world images. The generated images include ground truth data, which reduces the need to label large numbers of images for training datasets, thereby reducing computing resources typically required for generating large training datasets. Generating images for training datasets based on real world images rather than simulated images can also mitigate domain shift. Domain shift is when the images used to train a machine learning model differ appearance from images acquired at inference time. For example, using simulated images rendered by a software program to train and using real world images at inference time.

Generating simulated images by rendering can require large amounts of computing resources. Generating simulated images that try to mitigate domain shift by increasing resolution and details in the images can require even larger amounts of computing resources and may not succeed. Simulated images can be made more realistic by processing them with generative adversarial networks, which can increase the amount of computing resources used to generate training images. Machine learning models can be trained to compensate for domain shift by employing dual networks and cross-correlating intermediate latent variables when forming loss functions, again at an increase in required computing resources. Techniques described herein for generating training datasets mitigate domain shift without increasing required computing resources.

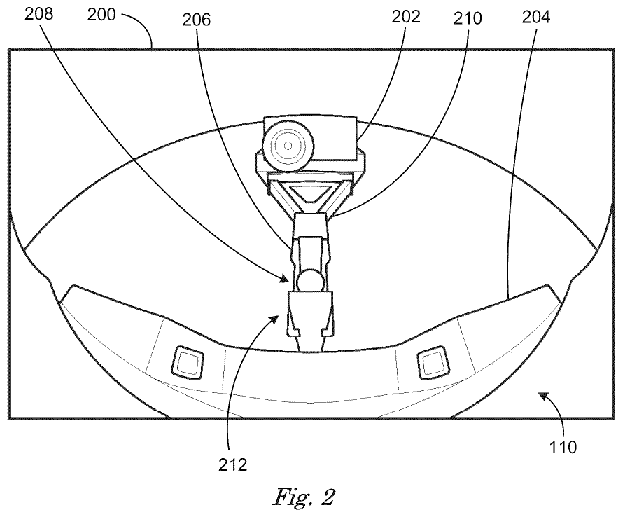

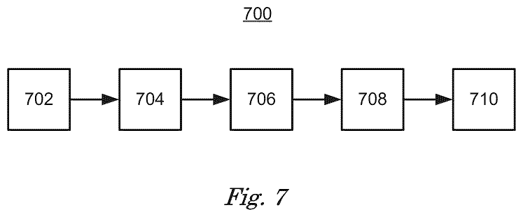

Techniques described herein for generating training datasets begin with acquiring limited numbers of representative images for each type of object to be identified and located by a machine learning model. In this example, a type of object can be a make and model of trailer. Representative images can be the trailer at three cardinal positions, namely zero degrees, 90 degrees and 180 degrees, or within +/−ten degrees of the cardinal positions. The images can be determined by inspecting acquired video data of trailers and selecting and labeling the representative images manually. Once the representative images are acquired and labeled, a software program executing on a server computer can transform the representative images, generate intermediate images and assemble them into a training dataset as described below in relation to FIGS. 2-6. A second software program executing on the server computer can train the machine learning model using the training dataset as described below in relation to FIG. 7, below.

A method is disclosed herein, including transforming fisheye images that include objects at first, second, and third angles into rectilinear images with a first image transformation. The rectilinear images can be transformed into bird's eye view images with a second image transformation. The bird's eye view images can be transformed into multiple images that include objects at multiple angles intermediate between the first, second, and third angles to generate a training dataset that includes ground truth regarding the objects at multiple angles with a third image transformation. A machine learning model can be trained with the training dataset. The first image transformation can be based on fisheye camera intrinsic parameters including fisheye distortion parameters. The second image transformation can be based on camera intrinsic parameters including focal length in x and y, optical center in x and y, magnification, optical center in x and y, and skew.

The second image transformation can be based on camera extrinsic parameters including camera six degree of freedom pose. The second image transformation can include an affine transformation that places a hitch ball at a predetermined location in the images. The first angle can be 0 degrees, the second angle is 90 degrees, and the third angle is 180 degrees. The third image transformation can be based on generating intermediate angle images at 10 degree increments between 0 degrees and 180 degrees. The machine learning model can be a convolutional neural network. The objects can include a trailer. The first, second and third angles can be based on an angle of a trailer tongue with respect to a location of a hitch ball. The machine learning model can be trained to determine a location and angle of the trailer tongue with respect to the location of the hitch ball. The trained machine learning model can be included in a second computer for a vehicle wherein the second computer is programmed to operate the vehicle by determining a vehicle trajectory based on predictions output from the trained machine learning model. The second computer can be programmed to operate the vehicle on the vehicle trajectory by commanding controllers to operate vehicle components. The convolutional neural network can include multiple convolutional layers and multiple fully connected layers.

Further disclosed is a computer readable medium, storing program instructions for executing some or all of the above method steps. Further disclosed is a computer programmed for executing some or all of the above method steps, including a computer apparatus, programmed to transforming fisheye images that include objects at first, second, and third angles into rectilinear images with a first image transformation. The rectilinear images can be transformed into bird's eye view images with a second image transformation. The bird's eye view images can be transformed into multiple images that include objects at multiple angles intermediate between the first, second, and third angles to generate a training dataset that includes ground truth regarding the objects at multiple angles with a third image transformation. A machine learning model can be trained with the training dataset. The first image transformation can be based on fisheye camera intrinsic parameters including fisheye distortion parameters. The second image transformation can be based on camera intrinsic parameters including focal length in x and y, optical center in x and y, magnification, optical center in x and y, and skew.

The instructions can also include instructions wherein the second image transformation can be based on camera extrinsic parameters including camera six degree of freedom pose. The second image transformation can include an affine transformation that places a hitch ball at a predetermined location in the images. The first angle can be 0 degrees, the second angle is 90 degrees, and the third angle is 180 degrees. The third image transformation can be based on generating intermediate angle images at 10 degree increments between 0 degrees and 180 degrees. The machine learning model can be a convolutional neural network. The objects can include a trailer. The first, second and third angles can be based on an angle of a trailer tongue with respect to a location of a hitch ball. The machine learning model can be trained to determine a location and angle of the trailer tongue with respect to the location of the hitch ball. The trained machine learning model can be included in a second computer for a vehicle wherein the second computer is programmed to operate the vehicle by determining a vehicle trajectory based on predictions output from the trained machine learning model. The second computer can be programmed to operate the vehicle on the vehicle trajectory by commanding controllers to operate vehicle components. The convolutional neural network can include multiple convolutional layers and multiple fully connected layers.

FIG. 1 is a diagram of an imaged based system 100. In this example, system 100 includes a vehicle 110, however, in other examples system 100 could include other devices that move and/or have movable components, such as a robot, a drone, or an object tracking device. In examples where system 100 includes a robot, a drone, or an object tracking device, controllers 112, 113, 114 would be changes to controllers that control robot, drone, or object tracking device components. In examples described herein, system 100 includes a vehicle 110, a computing device 115 included in the vehicle 110, and a server computer 120 remote from the vehicle 110. One or more vehicle 110 computing devices 115 can receive data regarding the operation of the vehicle 110 from sensors 116. The computing device 115 may operate vehicle 110 based on data received from the sensors 116 and data received from the remote server computer 120. The server computer 120 can communicate with the vehicle 110 via a network 130.

The computing device 115 includes a processor and a memory such as are known. Further, the memory includes one or more forms of computer-readable media, and stores instructions executable by the processor for performing various operations, including as disclosed herein. For example, the computing device 115 may include programming to operate one or more of vehicle brakes, propulsion (i.e., control of speed in the vehicle 110 by controlling one or more of an internal combustion engine, electric motor, hybrid engine, etc.), steering, climate control, interior and exterior lights, etc., as well as to determine whether and when the computing device 115, as opposed to a human operator, is to control such operations. The computing device 115 can also control the temporal alignment of lighting to sensor acquisition to account for the color effects of vehicle lights or external lights.

The computing device 115 may include or be communicatively coupled to, i.e., via a vehicle communications bus as described further below, more than one computing devices, i.e., controllers or the like included in the vehicle 110 for monitoring and controlling various vehicle components, i.e., a propulsion controller 112, a brake controller 113, a steering controller 114, etc. The computing device 115 is generally arranged for communications on a vehicle communication network, i.e., including a bus in the vehicle 110 such as a controller area network (CAN) or the like; the vehicle 110 network can additionally or alternatively include wired or wireless communication mechanisms such as are known, i.e., Ethernet or other communication protocols.

Via the vehicle network, the computing device 115 may transmit messages to various devices in vehicle 110 and receive messages from the various devices, i.e., controllers, actuators, sensors, etc., including sensors 116. Alternatively, or additionally, in cases where the computing device 115 actually comprises multiple devices, the vehicle communication network may be used for communications between devices represented as the computing device 115 in this disclosure. Further, as mentioned below, various controllers or sensing elements such as sensors 116 may provide data to the computing device 115 via the vehicle communication network.

In addition, the computing device 115 may be configured for communicating through a vehicle-to-infrastructure (V2I) interface 111 with a remote server computer 120, i.e., a cloud server, via a network 130, which, as described below, includes hardware, firmware, and software that permits computing device 115 to communicate with a remote server computer 120 via a network 130 such as wireless Internet (WI-FI®) or cellular networks. V2X interface 111 may accordingly include processors, memory, transceivers, etc., configured to utilize various wired and wireless networking technologies, i.e., cellular, BLUETOOTH®, Bluetooth Low Energy (BLE), Ultra-Wideband (UWB), Peer-to-Peer communication, UWB based Radar, IEEE 802.11, and other wired and wireless packet networks or technologies. Computing device 115 may be configured for communicating with other vehicles 110 through V2X (vehicle-to-everything) interface 111 using vehicle-to-vehicle (V-to-V) networks, i.e., according to including cellular communications (C-V2X) wireless communications cellular, Dedicated Short Range Communications (DSRC) and the like, i.e., formed on an ad hoc basis among nearby vehicles 110 or formed through infrastructure-based networks. The computing device 115 also includes nonvolatile memory such as is known. Computing device 115 can log data by storing the data in nonvolatile memory for later retrieval and transmittal via the vehicle communication network and a vehicle to infrastructure (V2I) interface 111 to a server computer 120 or user mobile device 160.

As already mentioned, generally included in instructions stored in the memory and executable by the processor of the computing device 115 is programming for operating one or more vehicle 110 components, i.e., braking, steering, propulsion, etc., without intervention of a human operator. Using data received in the computing device 115, i.e., the sensor data from the sensors 116, the server computer 120, etc., the computing device 115 may make various determinations and control various vehicle 110 components and operations. For example, the computing device 115 may include programming to control vehicle 110 operational behaviors (i.e., physical manifestations of vehicle 110 operation) such as speed, steering, etc., as well as tactical behaviors (i.e., control of operational behaviors typically in a manner intended to achieve efficient traversal of a route) such as a distance between vehicles and amount of time between vehicles, lane-change, minimum gap between vehicles, left-turn-across-path minimum, time-to-arrival at a particular location and intersection (without signal) minimum time-to-arrival to cross the intersection.

Controllers, as that term is used herein, include computing devices that typically are programmed to monitor and control a specific vehicle subsystem. Examples include a propulsion controller 112, a brake controller 113, and a steering controller 114. A controller may be an electronic control unit (ECU) such as is known, possibly including additional programming as described herein. The controllers may communicatively be connected to and receive instructions from the computing device 115 to actuate the subsystem according to the instructions. For example, the brake controller 113 may receive instructions from the computing device 115 to operate the brakes of the vehicle 110.

The one or more controllers 112, 113, 114 for the vehicle 110 may include known electronic control units (ECUs) or the like including, as non-limiting examples, one or more propulsion controllers 112, one or more brake controllers 113, and one or more steering controllers 114. Each of the controllers 112, 113, 114 may include respective processors and memories and one or more actuators. The controllers 112, 113, 114 may be programmed and connected to a vehicle 110 communications bus, such as a controller area network (CAN) bus or local interconnect network (LIN) bus, to receive instructions from the computing device 115 and control actuators based on the instructions.

Sensors 116 may include a variety of devices such as are known to provide data via the vehicle communications bus. For example, a radar fixed to a front bumper (not shown) of the vehicle 110 may provide a distance from the vehicle 110 to a next vehicle in front of the vehicle 110, or a global positioning system (GPS) sensor disposed in the vehicle 110 may provide geographical coordinates of the vehicle 110. The distance(s) provided by the radar and other sensors 116 and the geographical coordinates provided by the GPS sensor may be used by the computing device 115 to operate the vehicle 110 autonomously or semi-autonomously, for example.

The vehicle 110 is generally a land-based vehicle 110 capable of autonomous and semi-autonomous operation and having three or more wheels, i.e., a passenger car, light truck, etc. Vehicle 110 includes one or more sensors 116, the V2I interface 111, the computing device 115 and one or more controllers 112, 113, 114. Sensors 116 may collect data related to the vehicle 110 and the environment in which the vehicle 110 is operating. By way of example, and not limitation, sensors 116 may include, i.e., altimeters, cameras, LIDAR, radar, ultrasonic sensors, infrared sensors, pressure sensors, accelerometers, gyroscopes, temperature sensors, hall sensors, optical sensors, voltage sensors, current sensors, mechanical sensors such as switches, etc. The sensors 116 may be used to sense the environment in which the vehicle 110 is operating, i.e., sensors 116 can detect phenomena such as weather conditions (precipitation, external ambient temperature, etc.), the grade of a road, the location of a road (i.e., using road edges, lane markings, etc.), or locations of target objects such as neighboring vehicles 110. The sensors 116 may further be used to collect data including dynamic vehicle 110 data related to operations of the vehicle 110 such as velocity, yaw rate, steering angle, engine speed, brake pressure, oil pressure, power applied to controllers 112, 113, 114 in the vehicle 110, connectivity between components, and accurate and timely performance of components of the vehicle 110.

Server computer 120 typically has features in common (e.g., a computer processor and memory and configuration for communication via a network 130) with the vehicle 110 V2I interface 111 and computing device 115, and therefore these features will not be described further to reduce redundancy. A server computer 120 can be used to develop and train machine learning models that can be transmitted to a computing device 115 in a vehicle 110.

FIG. 2 is a diagram of an example fisheye image 200 acquired by a fisheye camera included in or on vehicle 110. A fisheye camera includes an ultra wide-angle (fisheye) lens that acquires images having an extremely wide field of view. Fisheye cameras are included in vehicle 110 because they can acquire image data from a field of view that would require two or more cameras having rectilinear lenses to cover. Fisheye image 200 includes trailer 202 attached to vehicle 110 via trailer tongue 210 and trailer coupler 206. The trailer coupler 206 rests on top of hitch ball 208 which is connected to vehicle 110 and bumper 204 by a trailer hitch 212.

Despite their advantage in covering a large field of view, a fisheye image 200 has the disadvantage of distorting objects in the field of view. Convex distortion included in the fisheye image 200 can cause lines that are straight in the real world to appear curved in the fisheye image 200, for example edges of the bumper 204. Furthermore, object distortion differs depending upon where the object is in the field of view, making processing fisheye image 200 with a machine learning model difficult. To overcome this difficulty, fisheye image 200 can be transformed into a rectilinear image using a fisheye-to-rectilinear transformation.

Acquiring a fisheye image 200 with a fisheye camera can be described mathematically as first projecting world coordinates, i.e., global coordinates included in a real-world traffic scene, into camera coordinates, i.e., coordinates measured relative to the camera sensor plane:

$$[ \begin{matrix}{X}_{C} \\ {Y}_{C} \\ {Z}_{C}\end{matrix} ] = {}_{}^{c} {R}_{W}^{} [ \begin{matrix}{X}_{W} \\ {Y}_{W} \\ {Z}_{W}\end{matrix} ] + {}_{}^{c} {t}_{W}^{} \qquad ( 1 )$$

In Equation 1, X_{W}, Y_{W}, Z_{W} are the three axis coordinates of a point in real-world coordinates, X_{C}, Y_{C}, Z_{C} are the three axis coordinates of a point in camera coordinates, ^{c}R_{W} is a 3×3 rotational matrix that rotates a point in three-dimensional space and ^{c}t_{W} is a 1×3 matrix that translates a point in three-dimensional space. Imaging a point in three-dimensional space with a fisheye lens can be modeled as projecting the point onto a unit sphere by the equation:

$$[ \begin{matrix}{X}_{S} \\ {Y}_{S} \\ {Z}_{S}\end{matrix} ] = [ \begin{matrix}\frac{{X}_{C}}{\sqrt{{X}_{C}^{2} + {Y}_{C}^{2} + {Z}_{C}^{2}}} \\ \frac{{Y}_{C}}{\sqrt{{X}_{C}^{2} + {Y}_{C}^{2} + {Z}_{C}^{2}}} \\ \frac{{Z}_{C}}{\sqrt{{X}_{C}^{2} + {Y}_{C}^{2} + {Z}_{C}^{2}}}\end{matrix} ] \qquad ( 2 )$$

In Equation 2, Xₛ, Yₛ, Zₛ are the three axis coordinates of a point projected on to the unit sphere. The point on the unit sphere is then projected onto a normalized plane to yield normalized coordinates x_{ud}, y_{ud} by the equation:

$$[ \begin{matrix}{x}_{ud} \\ {y}_{ud}\end{matrix} ] = [ \begin{matrix}\frac{{X}_{S}}{{Z}_{S} + ξ} \\ \frac{{Y}_{S}}{{Z}_{S} + ξ}\end{matrix} ] \qquad ( 3 )$$

Distortion parameters related to the fisheye lens distortion k₁, k₂, p₁, p₂, can be estimated by determining the intrinsic calibration of the fisheye lens. Intrinsic calibration includes the parameters that determine the fisheye lens distortion that occurs in addition to the distortion due to the spherical lens. The fisheye lens distortion parameters are applied to the normalized coordinates to transform the undistorted coordinates x_{ud}, y_{ud} to distorted coordinates x_{d}, y_{d}:

$$[ \begin{matrix}{x}_{d} \\ {y}_{d}\end{matrix} ] = [ \begin{matrix}{x}_{ud} ( 1 + {k}_{1} ( {x}^{2} + {y}^{2} ) + {{k}_{2} ( {x}^{2} + {y}^{2} )}^{2} ) + \\ 2 {p}_{1} {x}_{ud} {y}_{ud} + {p}_{2} ( ( {x}^{2} + {y}^{2} ) + 2 {x}^{2} ) \\ {y}_{ud} ( 1 + {k}_{1} ( {x}^{2} + {y}^{2} ) + {{k}_{2} ( {x}^{2} + {y}^{2} )}^{2} ) + \\ 2 {p}_{2} {x}_{ud} {y}_{ud} + {p}_{1} ( ( {x}^{2} + {y}^{2} ) + 2 {x}^{2} )\end{matrix} ] \qquad ( 4 )$$

A generalized camera projection matrix that converts the distorted, normalized fisheye coordinates into camera coordinates

$$p = [ \begin{matrix}u \\ v\end{matrix} ]$$

using camera parameters for focal length fₓ, f_{y} in x and y, optical center cₓ, c_{y} in x and y and skew s:

$$p = [ \begin{matrix}u \\ v\end{matrix} ] = [ \begin{matrix}{f}_{s} & s & {c}_{x} \\ 0 & {f}_{y} & {c}_{y}\end{matrix} ] [ \begin{matrix}{x}_{d} \\ {y}_{d} \\ 1\end{matrix} ] \qquad ( 5 )$$

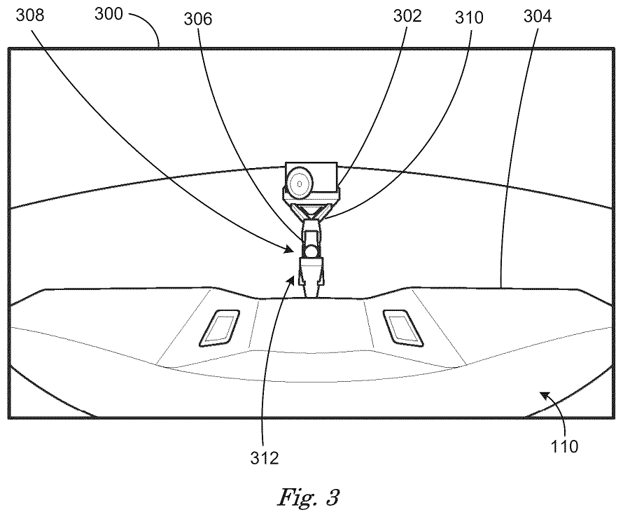

Applying equations (1)-(5) to real world coordinates X_{W}, Y_{W}, Z_{W} can yield camera coordinates p, i.e., applying equations (1)-(5) to a real world scene can yield a fisheye image 200. Equations (1)-(5) can be summarized by the equation:

$$F ( p ) = \prod ( ∅ ) \qquad ( 6 )$$

where F(p) is a fisheye image, Π is the transform that includes equations (1)-(5) and Ø is a set of data points in three-dimensional real-world coordinates. The fisheye-to-rectilinear transformation that transforms fisheye image 200 into a rectilinear image 300 as illustrated in FIG. 3 is based on reversing equations (1)-(5) above by inverting the matrix operations in equations (1)-(5).

Inverting the matrix operations in equations (1)-(5) can be based on camera intrinsic parameters of the fisheye camera including the lens used to acquire fisheye image 200. Intrinsic parameters include camera focal length fₓ, f_{y} in x and y, magnification, optical center cₓ, c_{y} in x and y, and skew s, which is a difference, if any, in angle from 90 degrees that the x and y dimensions form. Inverting the matrix operations can be based on fisheye camera intrinsic parameters. Intrinsic parameters include fisheye distortion parameters k₁, k₂, p₁, p₂, which can be determined by acquiring an image of a specified pattern, such as a checkerboard, at a specified distance from the camera and analyzing the resulting pattern.

Inverting the matrix can also be based on camera extrinsic parameters. Fisheye camera extrinsic parameters include the fisheye camera location in x, y, and z real world coordinates and the orientation of the camera in roll, pitch, and yaw rotational coordinates with respect to the x, y, and y axes. Camera extrinsic parameters include location coordinates in x, y, and z and camera rotation coordinates in roll, pitch and yaw which determine camera six degree of freedom pose. The extrinsic parameters can be measured with respect to a ground plane, for example a roadway that supports vehicle 110 that includes the fisheye camera.

FIG. 3 is a diagram of a rectilinear image 300 determined by transforming fisheye image 200 using the fisheye-to-rectilinear transformation described in relation to FIG. 2, above. Rectilinear image 300 includes the same elements as fisheye image 200, namely trailer 302, vehicle bumper 304, trailer tongue 310 and trailer coupler 306, which connect trailer 202 to vehicle 110 via hitch ball 308 and trailer hitch 312. Although rectilinear image 300 is free of fisheye distortion, rectilinear image 300 still includes perspective distortion, which changes apparent size, shape and location of objects depending upon their distance from the camera. For example, the bumper 304 is changed from its real world rectangular shape and appears to be larger than the trailer 302. Perspective distortion changes with the location of objects with respect to the optical center of the image. Changing the shape, size and location of objects can introduce variance in results obtained from a trained machine learning model.

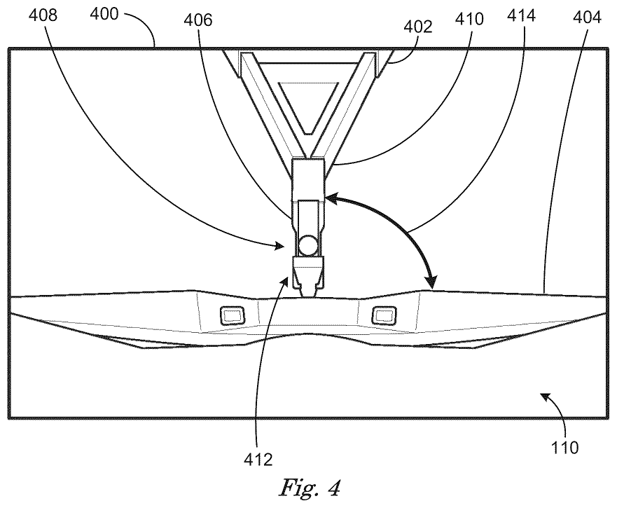

Techniques discussed herein for generating training datasets for machine learning models can mitigate the effects of perspective distortion in rectilinear images 300 by performing a rectilinear-to-bird's eye view transformation. A rectilinear-to-bird's eye view transformation uses intrinsic and extrinsic camera parameters to transform a rectilinear image acquired from a camera location included in a vehicle into a bird's eye view image 400 as illustrated in FIG. 4. Homography is a type of image transformation that describes the relationship between two images of the same planar object taken from different positions. Determining a bird's eye view image 400 from a rectilinear image can be performed by applying a homography matrix H to the pixels of the rectilinear image 300 R to form a bird's eye view image 400 B using matrix multiplication:

$$B = H * R \qquad ( 7 )$$

Where the homography matrix H is a 3×3 matrix:

$$H = \vert \begin{matrix}{h}_{11} & {h}_{12} & {h}_{13} \\ {h}_{21} & {h}_{22} & {h}_{23} \\ {h}_{31} & {h}_{32} & {h}_{33}\end{matrix} \vert \qquad ( 8 )$$

Where the elements hᵢⱼ of the homography matrix H are determined based on the focal length of the video camera in x and y, the vanishing point of the image and horizon line determined with respect to a ground plane and the rotation and tilt of the video camera with respect to the ground plane. Determination of the homography matrix H is described in “A Geometric Approach to Obtain a Bird's Eye View from an Image”, Ammar Abbas and Andrew Zisserman. This article is available at https://arxiv.org/abs/1905.02231 as of the filing date of this application.

FIG. 4 is a diagram of a bird's eye view image 400. The bird's eye view image 400 is generated from a rectilinear image 300 based on the transformation described in relation to FIG. 3. Bird's eye view image 400 includes a bumper 404 attached to a vehicle 110, a hitch coupler 406 and a trailer tongue 410. The hitch coupler 406 and a trailer tongue 410 can be connected to vehicle 110 via a hitch ball 408 beneath the hitch coupler 406 and trailer hitch 412. Bird's eye view image 400 permits more accurate processing by a machine learning model by mitigating perspective distortion included in rectilinear image 300. In particular, bird's eye view image 400 permits more accurate determination of the trailer angle 414 between hitch coupler 406 and bumper 404 by a machine learning model than in rectilinear image 300 that includes perspective distortion.

A bird's eye view image 400 can be further enhanced to permit accurate determination of trailer angle 414 by translating the pixels of bird's eye view image 400 to place the center of the hitch ball 408 at a predetermined location in bird's eye view image 400. Because camera extrinsic parameters and camera intrinsic parameters are determined at manufacturing time, the location and orientation of the hitch ball 408 in bird's eye view image 400 can be determined. To enhance the accuracy of trailer angle 414 determination by a machine learning model the pixels of bird's eye view image 400 can be translated and rotated by image processing software that performs an affine transformation to place the hitch ball 408 at a predetermined location and orientation in bird's eye view image 400. Bird's eye view image 400 can also be adjusted for field of view by changing the zoom factor to make the trailer 402, trailer tongue 410 and hitch coupler 406 the same size in the bird's eye view images 400.

Techniques described herein can enhance training a machine learning model to determine trailer angle 414 by having the hitch ball 408 at the same location and orientation and having the trailer 402, trailer tongue 410 and hitch coupler 406 the same size and location during training and inference. Having the hitch ball 408 at the same location and orientation and having the trailer 402, trailer tongue 410 and hitch coupler 406 the same size and location during training and inference can reduce training time which reduces the computing resources required to train the machine learning model and can increase the accuracy of trailer angle 414 determination at inference time.

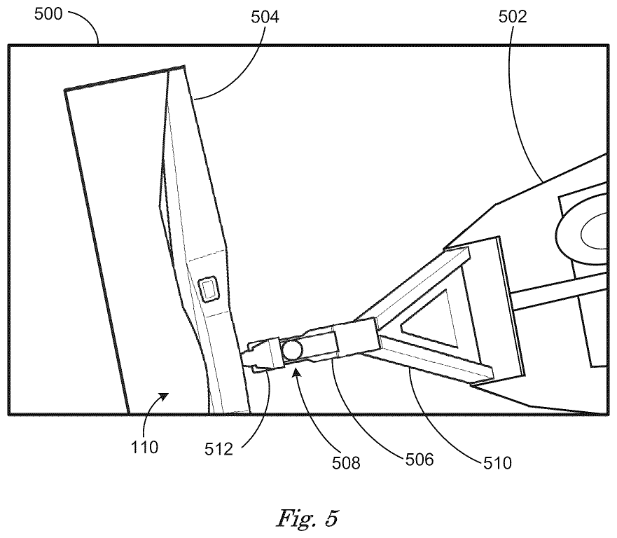

FIG. 5 is a diagram of a rotated image 500. Rotated image 500 is formed by rotating an entire bird's eye view image 400 using image processing software that performs an affine transformation on the pixels of bird's eye view image 400. Following rotation, portions of bird's eye view image 400 that have been rotated out of the rectangular frame of rotated image 500 can be cropped. For example, first trailer angle 414 can be 90 degrees. Bird's eye view image 400 can be rotated 80 degrees clockwise around the location of hitch ball 508, for example, to form a rotated image 500 which includes rotating vehicle 110, bumper 504, hitch coupler 506, trailer hitch 512, trailer 502, trailer tongue 510 and hitch connector 508.

Bird's eye view images 400 can be rotated at 10 degree increments to yield multiple intermediate angle images between 0 and 180 degrees, for example. The input bird's eye view images 400 can include images that include varying trailer angles 414. The input bird's eye view images 400 can include trailer angles 414 equal to 0, 90 and 180 degrees, called cardinal trailer angles after the cardinal compass directions. (e.g., North, South, East, and West). Techniques described herein can work with any number of bird's eye view images 400, however, three bird's eye view images 400 at each of the cardinal angles are optimum. The bird's eye view images 400 can be rotated either clockwise or counterclockwise, depending upon which of the cardinal angle images is closest in angle to the desired intermediate trailer angle 414.

In some examples the input data might only include one or two images acquired at random trailer angles between 0 and 180 degrees. Techniques described herein for generating training datasets can work with fewer than three bird's eye view images 400 and three bird's eye view images 400 acquired and angles other than the cardinal angles, however, three bird's eye view images 400 at each of the cardinal angles are optimum.

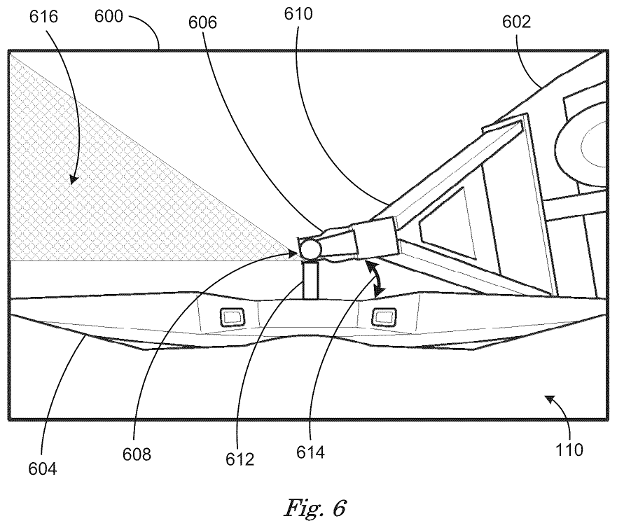

FIG. 6 is a diagram of a synthetic image 600. Synthetic image 600 is formed by cropping portions of rotated image 500 that include vehicle 110, bumper 504, and trailer hitch 512 based on determining a mask based on the bird's eye view image 400. The location of the mask can be determined based on data regarding the location and size of the vehicle 110, trailer hitch 412 and bumper 404 determined based on image data available at manufacturing time. Because the intrinsic and extrinsic camera parameters do not change, the mask location will be the same for subsequently acquired images. The mask can be used to crop portions of the rotated image 500 including vehicle 110, bumper 504, and trailer hitch 512 from the rotated image 500. The mask can be rotated around the location of the hitch ball 508 to place the cropped portion of the rotated image 500 back to their original positions similar to their positions in the bird's eye view image 400, leaving a blank portion 616. The cropped portion can then be pasted into the synthetic image at the positions of the vehicle 110, bumper 404 and trailer hitch 412 in the bird's eye view image 400 to form a synthetic image 600 that includes the vehicle 110, bumper 604, and trailer hitch 612 leaving the trailer 602, trailer tongue 610 and hitch connector 608 at their rotated positions.

The blank portions 616 of the synthetic image 600 can then be filled with roadway textures from the bird's eye view image 400 by suitable image processing techniques to form a synthetic image 500 that includes a trailer 602 at a new trailer angle 614 with respect to vehicle 110. The roadway textures can be obtained from the bird's eye view image 400, for example. Determining training dataset images in this fashion permits generation of large numbers of training images with precisely known ground truth data, (e.g., the trailer angle 614) based on the input rotation angle applied to a small number (1-3) of input fisheye images 200. This technique for generating training dataset images enhances training dataset generation by reducing the number of images required to be processed to determine ground truth and eliminates or reduces the need for photorealistically rendered images both of which reduce the amount of computing resources required to generate a training dataset. Generating training dataset images in this fashion also reduces the need to employ generative adversarial neural networks or multi-path unsupervised learning to make rendered images more realistic for training, thus reducing the computing resources required for training a machine learning model.

FIG. 7 is a diagram of a dataset generation system 700. Dataset generation system is a software program which can execute on a server computer 120. Dataset generation system receives a fisheye image 702 at fisheye-to-rectilinear transformation 704 which transforms a fish eye image 702 to a rectilinear image 300 as described above in relation to FIG. 2. Fisheye-to-rectilinear transformation 704 outputs a rectilinear image 300 to rectilinear-to-bird's eye view transformation 706 that transforms the rectilinear image 300 to a bird's eye view image 400 while correcting the location and scale as described above in relation to FIG. 3.

Rectilinear-to-bird's eye view transformation 706 outputs a bird's eye view image 400 to angle transformation 708. Angle transformation 708 receives a bird's eye view image 400 at a first trailer angle 410 and angle transformation 708 rotates the received bird's eye view image 400 to form a rotated image 500 a second trailer angle 614 and crops and blends the rotated image 500 to form a synthetic image 600. The synthetic image 600 uses elements from the rotated image 500 to make an image that appears as if it were a real world image acquired at the second trailer angle 614.

The dataset generation system 700 is programmed to input a set of one to three real world images acquired at one or more cardinal trailer angles, for example, zero degrees, 90 degrees, and 180 degrees. The dataset generation system 700 is programmed to generate a series of synthetic images 600 from the input images that include trailer angles 614 from zero to 180 degrees at selected increments, for example 10 degrees. The dataset generation system 700 selects the input image that is closest to a selected trailer angle 614 and uses that input image to generate the selected trailer angle 614. Angle transformation 708 generates the series of synthetic images 600 at the selected intermediate trailer angles 614 and outputs them to the training dataset 710. The training dataset 710 includes the synthetic images 600 and ground truth data regarding the trailer angles 614 included in the synthetic images 600.

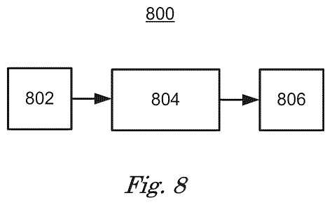

FIG. 8 is a diagram of a machine learning model training system 800. Machine learning model training system 800 is a software program that can execute on server computer 120 to train a machine learning model 804. Machine learning model 804 can be a convolutional neural network, for example. A convolutional neural network can include multiple convolutional layers followed by multiple fully connected layers. The convolutional neural network receives an input image 802 from the training dataset 710 and outputs a prediction 806 regarding the trailer angle 614 included in the input image 802.

Machine learning model 804 can be trained by receiving an input image 802, generating a prediction 806 regarding the trailer angle 614 included in the input image 802. Trailer angle 614 prediction 806 can be compared to a ground truth trailer angle included in training dataset 710 to determine a loss function. A loss function indicates how closely trailer angle 614 prediction 806 compares to or matches the ground truth trailer angle. The machine learning model training system 800 can repeat the process hundreds or thousands of times for each image while back propagating the loss function through the layers of the machine learning model 804 to determine the weights that program the layers of the machine learning model 804. The process can be repeated until the loss function converges to a minimum value. The weights that yield the minimum value of the loss function can be stored as the weights included in a trained machine learning model 804. The training process for a single image 802 can be repeated multiple times for the images 802 included in the training dataset 710.

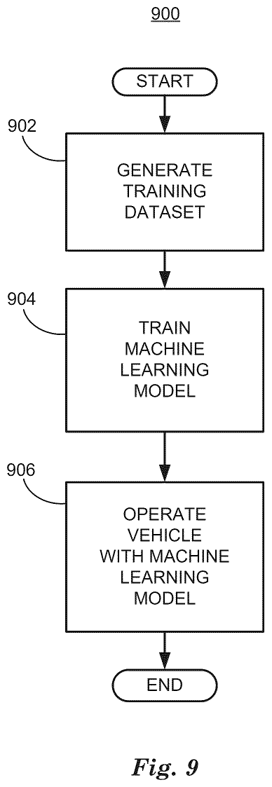

FIG. 9 flowchart diagram of a process 900 for operating a vehicle 110 based on a trained machine learning model 804. Process 900 can be implemented as hardware and software executing on a server computer 120 to train the machine learning model 804 which is then transmitted to a computing device 115 included in a vehicle 110 to operate the vehicle 110. Process 900 includes multiple blocks that can be executed in the illustrated order. Process 900 could alternatively or additionally include fewer blocks and can include the blocks executed in different orders.

At block 902 a first software program executing on server computer 120 generates a training dataset 710 based on a limited number of images acquired at cardinal trailer angle positions as described above in relation to FIGS. 2-7.

At block 904 a second software program executing on server computer 120 uses the training dataset 710 to train a machine learning model 804 as described above in relation to FIG. 8.

At block 906 the trained machine learning model 804 can be transmitted from the server computer 120 to a computing device 115 included in a vehicle 110. Computing device 115 can acquire data from sensors included in vehicle 110 including a video camera. The trained machine learning model 804 can receive images from the video camera and determine a prediction 806 regarding a trailer angle 614 included in the acquired image. Computing device 115 can determine a vehicle trajectory, which, when operated upon by the computing device 115, can cause the vehicle 110 to position the hitch ball 608 beneath the hitch coupler 606 to permit the trailer 602 to be hitched to the vehicle 110. The vehicle trajectory can be determined by assuming a “bicycle” model for vehicle 110 which can model the front steering wheels as a first single wheel and the rear driving wheels as a second single wheel. Computing device 115 can determine the steering angle of the front wheel while applying power to the rear wheel so as to move the hitch ball 608 to place it beneath the hitch coupler 606. This technique can be modified for front-wheel drive and all-wheel drive vehicles as required. Computing device 115 can operate the vehicle by determining commands to transmit to controllers 112, 113, 114 to control vehicle components to cause vehicle 110 to operate on the determined vehicle trajectory. Following block 906, process 900 ends.

Any action taken by a vehicle or user of the vehicle should comply with all rules and regulations specific to the location and operation of the vehicle (e.g., Federal, state, country, city, etc.). More so, any operations disclosed herein are for illustrative purposes only. Certain operations may be modified and omitted depending on the context, situation, and applicable rules and regulations. Further, regardless of the operations or determinations, users should use good judgement and common sense when operating the vehicle. That is, all operations, whether standard or “enhanced,” should be followed only when proper to do so and when in compliance with any rules and regulations specific to the location and operation of the vehicle.

Computing devices such as those described herein generally each includes commands executable by one or more computing devices such as those identified above, and for carrying out blocks or steps of processes described above. For example, process blocks described above may be embodied as computer-executable commands.

Computer-executable commands may be compiled or interpreted from computer programs created using a variety of programming languages and technologies, including, without limitation, and either alone or in combination, Java™, C, C++, Python, Julia, SCALA, Visual Basic, Java Script, Perl, HTML, etc. In general, a processor (i.e., a microprocessor) receives commands, i.e., from a memory, a computer-readable medium, etc., and executes these commands, thereby performing one or more processes, including one or more of the processes described herein. Such commands and other data may be stored in files and transmitted using a variety of computer-readable media. A file in a computing device is generally a collection of data stored on a computer readable medium, such as a storage medium, a random access memory, etc.

A computer-readable medium (also referred to as a processor-readable medium) includes any non-transitory (i.e., tangible) medium that participates in providing data (i.e., instructions) that may be read by a computer (i.e., by a processor of a computer). Such a medium may take many forms, including, but not limited to, non-volatile media and volatile media. Instructions may be transmitted by one or more transmission media, including fiber optics, wires, wireless communication, including the internals that comprise a system bus coupled to a processor of a computer. Common forms of computer-readable media include, for example, RAM, a PROM, an EPROM, a FLASH-EEPROM, any other memory chip or cartridge, or any other medium from which a computer can read.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

The term “exemplary” is used herein in the sense of signifying an example, i.e., a candidate to an “exemplary widget” should be read as simply referring to an example of a widget.

The adverb “approximately” modifying a value or result means that a shape, structure, measurement, value, determination, calculation, etc. may deviate from an exactly described geometry, distance, measurement, value, determination, calculation, etc., because of imperfections in materials, machining, manufacturing, sensor measurements, computations, processing time, communications time, etc.

In the drawings, the same reference numbers indicate the same elements. With regard to the media, processes, systems, methods, etc. described herein, it should be understood that, although the steps or blocks of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

1. A system, comprising:
a computer that includes a processor and a memory, the memory including instructions executable by the processor to:
transform fisheye images that include objects at first, second, and third angles into rectilinear images with a first image transformation;
transform the rectilinear images into bird's eye view images with a second image transformation;
transform the bird's eye view images into multiple images that include objects at multiple angles intermediate between the first, second, and third angles to generate a training dataset that includes ground truth regarding the objects at multiple angles with a third image transformation; and
train a machine learning model with the training dataset.

2. The system of claim 1, wherein the first image transformation is based on fisheye camera intrinsic parameters including fisheye distortion parameters.

3. The system of claim 1, wherein the second image transformation is based on camera intrinsic parameters including focal length in x and y, optical center in x and y, magnification, optical center in x and y, and skew.

4. The system of claim 3, wherein the second image transformation is based on camera extrinsic parameters including camera six degree of freedom pose.

5. The system of claim 4, wherein the second image transformation includes an affine transformation that places a hitch ball at a predetermined location in the images.

6. The system of claim 1, wherein the first angle is 0 degrees, the second angle is 90 degrees, and the third angle is 180 degrees.

7. The system of claim 1, wherein the third image transformation is based on generating intermediate angle images at 10 degree increments between 0 degrees and 180 degrees.

8. The system of claim 1, wherein the machine learning model is a convolutional neural network.

9. The system of claim 1, wherein the objects include a trailer.

10. The system of claim 1, wherein the first, second and third angles are based on an angle of a trailer tongue with respect to a location of a hitch ball.

11. The system of claim 10, wherein the machine learning model is trained to determine a location and angle of the trailer tongue with respect to the location of the hitch ball.

12. The system of claim 1, wherein the trained machine learning model is included in a second computer for a vehicle wherein the second computer is programmed to operate the vehicle by determining a vehicle trajectory based on predictions output from the trained machine learning model.

13. The second computer of claim 12, wherein the second computer is programmed to operate the vehicle on the vehicle trajectory by commanding controllers to operate vehicle components.

14. A method, comprising:
transforming fisheye images that include objects at first, second, and third angles into rectilinear images with a first image transformation;
transforming the rectilinear images into bird's eye view images with a second image transformation;
transforming the bird's eye view images into multiple images that include objects at multiple angles intermediate between the first, second, and third angles to generate a training dataset that includes ground truth regarding the multiple angles with a third image transformation; and
training a machine learning model with the training dataset.

15. The method of claim 14, wherein the first image transformation is based on fisheye camera intrinsic parameters including fisheye distortion parameters.

16. The method of claim 14, wherein the second image transformation is based on camera intrinsic parameters including focal length in x and y, optical center in x and y, magnification, optical center in x and y, and skew.

17. The method of claim 16, wherein the second image transformation is based on camera extrinsic parameters including camera six degree of freedom pose.

18. The method of claim 17, wherein the second image transformation includes an affine transformation that places a hitch ball at a predetermined location in the images.

19. The method of claim 14, wherein the first angle is 0 degrees, the second angle is 90 degrees, and the third angle is 180 degrees.

20. The method of claim 14, wherein the third image transformation is based on generating intermediate angle images at 10 degree increments between 0 degrees and 180 degrees.
